(19) United States
(12) Patent Application Publication
(10) Pub. No.: US 2025/0297038 A1
(43) Pub. Date: Sep. 25, 2025

(54) SUSTAINABLE ESTERIFICATION OF SEAWEED CARBOHYDRATES WITH FATTY ACID DERIVATIVES

(71) Applicant: KELP INDUSTRIES LTD, Bristol (GB)

(72) Inventors: Christopher CHUCK, Bristol (GB); Stefanie FEDERLE, Bath (GB); Marco PICCINI, Bath (GB)

(73) Assignee: KELP INDUSTRIES LTD, Bristol, GB (GB)

(21) Appl. No.: 18/863,479

(22) PCT Filed: May 10, 2023
(86) PCT No.: PCT/GB2023/051221

§ 371 Date: Nov. 6, 2024

(30) Foreign Application Priority Data
May 10, 2022 (GB) 2206804.3

(51) Int. Cl. C08B 37/00

(52) U.S. Cl. CPC C08B 37/0039

(57) ABSTRACT

The present invention provides a method of preparing a fatty acid derivative of a polysaccharide derived from seaweed. The method comprises reacting at least one polysaccharide derived from seaweed with a fatty acid source comprising: a fatty acid or fatty acid ester; an activator; and a solvent.

The present invention relates to an improved method for preparing fatty acid esters of polysaccharides derived from seaweed.

### BACKGROUND OF INVENTION

There are a number of significant challenges involved in the replacement of petroleum-derived plastic materials with biomass-derived alternatives, such as feedstock sourcing and cost, processing conditions and final material performance.

Carbohydrates, including seaweed-derived polysaccharides such as sodium alginate, agar and carrageenan, are promising biopolymers for the production of novel biomaterials. However, due to the hydrophilic nature of these carbohydrates direct replacement of fossil-derived plastics, which demonstrate highly water resistant properties, is not attainable. One possible route to increase the hydrophobic nature of these biopolymers is the esterification reaction with long chain fatty acid derivatives. This esterification process converts polar hydroxyl groups of the polysaccharide into hydrophobic esters with long alkane chains. While the conversion can be hindered by low reactivity and solubility issues of the carbohydrate starting materials, the formed modified ester derivatives exhibit promising properties for bioplastics applications.

As such, carbohydrate long-chain esters are traditionally manufactured by recurring to acyl chlorides and excess organic bases. Although this route is efficient, said substances are highly toxic to humans and the environment, and represent a significant cost and ultimately a barrier to industrial production and commercialisation.

So far, alternative processes have mainly focused on replacing acyl chlorides with lower-cost fatty acids and esters. However, due to the lower reactivity of these derivatives and the abovementioned intrinsic low reactivity of polysaccharides, the extent of functionalisation is often very limited, resulting in poor product performance preventing commercial exploitation.

Esterification pathways that are more sustainable and easy to scale are therefore needed, while maintaining a high degree of functionalisation and product performance.

### STATEMENT OF INVENTION

According to a first aspect of the present invention, there is provided a method of preparing a fatty acid derivative of polysaccharide derived from seaweed, comprising:
reacting at least one polysaccharide derived from seaweed with a fatty acid source comprising: a fatty acid or fatty acid ester; an activator; and a solvent.

Reference hereinbelow to “polysaccharide” should be interpreted as meaning “polysaccharide derived from seaweed”. The term “Polysaccharide derived from seaweed” includes “macroalgal polysaccharide” and a “phycocolloid”. Thus, in one embodiment “polysaccharide derived from seaweed” is macroalgal polysaccharide. In one embodiment “polysaccharide derived from seaweed” is a phycocolloid.

### BRIEF DESCRIPTION OF FIGURES

FIG. 1 is an infrared spectroscopy graph comparing the absorption peaks for agar, palmitic acid and for agar functionalised with a palmitic acid source (Example 4).

FIG. 2 shows a water drop on the surface of a sheet of agar functionalised with palmitic acid (Example 6).

### DETAILED DESCRIPTION

The method of the invention provides the fatty acid derivatives having a high degree of functionalisation, while avoiding the use of fatty acid acyl chlorides. The fatty acid derivatised polysaccharides produced by the method of the invention are hydrophobic and have excellent water barrier properties, as shown in Example 6.

In the method of the invention, the polysaccharide derived from seaweed is derivatised to form a proportion of fatty acid ester moieties. Specifically, a proportion of the hydroxyl groups of the polysaccharide are esterified to form fatty acid ester moieties. Thus, in one embodiment the fatty acid derivative is a fatty acid ester, wherein at least a proportion of the hydroxyl groups of the polysaccharide obtained from seaweed have been esterified to form fatty acid esters.

In one embodiment, the method of the invention provides a fatty acid derivative wherein at least 20% of the hydroxyl groups of the polysaccharide obtained from seaweed have been esterified to form fatty acid esters, such as at least 25%, at least 30%, at least 35%, at least 40%, at least 45%, at least 50%, at least 55%, at least 60%, at least 65%, at least 70%, at least 75% or at least 80%.

The functionalisation yield (corresponding to the % of hydroxyl groups of the polysaccharide derived from seaweed that have been esterified) is determined as set out in the Evaluation Methods.

The at least one polysaccharide derived from seaweed is preferably selected from one or more of: an alginate salt (e.g. sodium alginate, calcium alginate or potassium alginate), agar (technical or biological grade), agarose, ulvan, carrageenan, alginic acid, fucoidan, laminarin, or any combination thereof.

Preferably the at least one polysaccharide derived from seaweed is selected from agar (technical or biological grade) and/or carrageenan. Preferably the at least one polysaccharide is agar (technical or biological grade).

In one embodiment, the fatty acid source is a fatty acid. In another embodiment, the fatty acid source is a fatty acid ester. When the fatty acid source is a fatty acid ester, it will react to form the fatty acid in situ, under the reaction conditions of the method. Preferably, the fatty acid source is a fatty acid.

The fatty acid source preferably has a chain length of at least C₁₂. For the avoidance of doubt, the “chain length” includes the carbon attached to the carbonyl group (e.g. an example of a C₁₂ fatty acid source is lauric acid). In one embodiment, the chain is branched. In another embodiment, the chain is unbranched. Preferably, the chain is unbranched. In one embodiment, the chain contains unsaturation. In another embodiment, the chain is saturated. Preferably, the chain is saturated. Preferably, the fatty acid source has a chain length of no more than C₁₈. Preferably, the fatty acid source has a chain length of one or more of: C₁₂, C₁₆, and/or C₁₈.

The at least one fatty acid is preferably selected from: octanoic acid, lauric acid, linoleic acid, palmitic acid, stearic acid, myristic acid, or any combination thereof. The at least one fatty acid is preferably selected from: lauric acid, myristic acid, palmitic acid, stearic acid, or any combination thereof. The at least one fatty acid is preferably selected from: palmitic acid or stearic acid, or any combination thereof.

The at least one fatty acid ester is preferably selected from one or more of: an octanoate ester, a laurate ester, a linoleate ester, a palmitate ester, a stearate ester, a myristate ester, or any combination thereof. The at least one fatty acid ester is preferably selected from a laurate ester, a myristate ester, a palmitate ester, a stearate ester, or any combination thereof. The at least one fatty acid ester is preferably a methyl, ethyl, vinyl or glyceryl ester of the at least one fatty acid. The at least one fatty acid ester is preferably selected from methyl palmitate, ethyl palmitate, glyceryl palmitate, vinyl palmitate, methyl stearate, ethyl stearate, vinyl stearate, glyceryl stearate or any combination thereof. The at least one fatty acid ester is preferably selected from methyl palmitate and/or methyl stearate.

In the method of the invention, typically a suspension of (the at least one) polysaccharide obtained from seaweed in a solvent is prepared, and then the (at least one) fatty acid source is added to the suspension.

In one embodiment, the molar ratio of the at least one fatty acid source to the polymer repeat unit of the at least one polysaccharide (within the reaction mixture) is at least 0.1:1, for example at least 0.5:1. In one embodiment, the ratio of the at least one fatty acid source to the polymer repeat unit of the at least one polysaccharide (within the reaction mixture) is no more than 10:1.

The at least one fatty acid source is preferably in stoichiometric excess to the polymer repeat unit of the at least one polysaccharide (within the reaction mixture). For example, the molar ratio of the at least one fatty acid source to the polymer repeat unit of the at least one polysaccharide (within the reaction mixture) is preferably at least 1.1:1, preferably at least 1.5:1, preferably at least 2:1, preferably at least 3:1, for example 5:1.

Thus, in one embodiment, the molar ratio of the at least one fatty acid source to the polymer repeat unit of the at least one polysaccharide is in the range of from 0.1:1 to 10:1, such as from 0.5:1 to 10:1, from 1.1:1 to 10:1 or from 1.5:1 to 10:1. Preferably the molar ratio of the at least one fatty acid source to the polymer repeat unit of the at least one polysaccharide is in the range of from 2:1 to 10:1, preferably from 3:1 to 10:1.

The method may further comprise drying the at least one polysaccharide derived from seaweed prior to functionalisation. The at least one polysaccharide derived from seaweed may be oven dried, for example at 50° C.

In one embodiment, the solvent is selected from the group consisting of water, ethanol, acetonitrile, 1,4-dioxane, ethyl butyrate, dimethylacetamide (DMAc), dimethylformamide (DMF), formamide, toluene, dimethylsulfoxide (DMSO), pyridine, chloroform, dichloromethane, dimethylacetamide/lithium chloride, imidazole and 1-methylimidazole; and combinations thereof. In one embodiment, the solvent is selected from the group consisting of DMAc, DMF, formamide, toluene, DMSO, pyridine, chloroform, dichloromethane, dimethylacetamide/lithium chloride, imidazole, and 1-methylimidazole; and any combination thereof. Preferably, the solvent is selected from the group consisting of DMAc, DMF, formamide, pyridine, imidazole and 1-methylimidazole; and combinations thereof. In one embodiment, the solvent is DMAc, DMF, pyridine, imidazole or 1-methylimidazole; or a combination thereof. In one embodiment, the solvent is DMAc, DMF, pyridine or imidazole; or a combination thereof. In one embodiment, the solvent is DMAc, pyridine, imidazole or 1-methylimidazole; or a combination thereof. In one embodiment, the solvent is pyridine. In one embodiment, the solvent is DMAc or DMF, in particular DMAc. In one embodiment, the solvent is imidazole.

Suitably, the solvent is non aqueous. In the context of the present invention, non aqueous refers to solvent that contains less than 1% (v/v), such as less than 0.5% (v/v), 0.4% (v/v), 0.3% (v/v), 0.2% (v/v), 0.1% (v/v), 0.05% (v/v) or 0.01% (v/v) of water.

In one embodiment, the solvent (total solvent if combinations of solvents are used) is present in the reaction mixture in an amount of 1-250 ml per gram of polysaccharide derived from seaweed e.g. 2-50 ml of solvent, 4-30 mL of solvent or about 15 mL of solvent is used for every gram of polysaccharide derived from seaweed.

In the context of the present invention, the activator is a moiety that is capable of enhancing the electrophilicity of the fatty acid source (in particular the fatty acid) carbonyl group, or it is a moiety that is capable of converting the hydroxyl groups of the polysaccharide into better leaving groups. The exact mechanism of the activator may be a combination of mechanisms, or it may be unknown. For example, it is hypothesized in the literature that using p-toluenesulfonyl chloride as activator may result in sulphonate formation of the fatty acid source (in particular fatty acid) and/or activation of the alcohol groups of the polysaccharide by conversion to sulphonate groups.

The activator is a chemical moiety rather than a biological moiety. For example, the activator is not an enzyme. The activator is not a catalyst for the esterification reaction. In particular, the activator is not a strong acid catalyst or a strong base catalyst. Thus, in one embodiment, the reaction mixture does not contain added strong acid or added strong base.

The activator is preferably selected from one or more of: N,N′-dicyclohexylcarbodiimide (DCC), p-toluenesulfonyl chloride (TsCl), trifluoromethanesulfonyl chloride, methanesulfonyl chloride (MsCl), 1,1′-carbonyldiimidazole (CDI), N,N′-diisopropylcarbodiimide (DIC), acetic anhydride, trifluoroacetic anhydride, or any combination thereof. Suitably, the activator is selected from the group consisting of N,N′-dicyclohexylcarbodiimide (DCC), p-toluenesulfonyl chloride (TsCl), trifluoromethanesulfonyl chloride, methanesulfonyl chloride (MsCl), 1,1′-carbonyldiimidazole (CDI), N,N′-diisopropylcarbodiimide (DIC) and trifluoroacetic anhydride; and in particular is selected from the group consisting of N,N′-dicyclohexylcarbodiimide (DCC), p-toluenesulfonyl chloride (TsCl), trifluoromethanesulfonyl chloride, methanesulfonyl chloride (MsCl), 1,1′-carbonyldiimidazole (CDI) and N,N′-diisopropylcarbodiimide (DIC). In one embodiment, the activator is preferably selected from one or more of: trifluoromethanesulfonyl chloride, p-toluenesulfonyl chloride, methanesulfonyl chloride, or any combination thereof. In one embodiment, the activator is preferably selected from one or more of: p-toluenesulfonyl chloride, methanesulfonyl chloride, or any combination thereof. In a preferred embodiment, the activator is p-toluenesulfonyl chloride.

Suitably, the activator is present in the reaction mixture at a proportion of 2-20 molar equivalents vs. the polysaccharide repeat unit, such as 2-10 molar equivalents or 5-8 molar equivalents. In one embodiment, 4-6 molar equivalents of activator (vs. the polysaccharide repeat unit) are present, such as about 5 molar equivalents.

In one embodiment, the activator is used together with a base. In one embodiment, the base is a nitrogen-containing (in particular an amine-containing) organic base. Suitably, the base is selected from the group consisting of pyridine, triethylamine, 4-dimethylaminopyridine (DMAP), imidazole and 1-methylimidazole; and mixtures thereof. In one embodiment, the base is selected from the group consisting of pyridine, DMAP, imidazole and 1-methylimidazole; and mixtures thereof. In one embodiment, the base is selected from the group consisting of pyridine, DMAP and imidazole; and mixtures thereof, and in particular is pyridine, imidazole, 1-methylimidazole or a mixture thereof. In one embodiment the base is pyridine. In one embodiment, the base is imidazole and/or 1-methylimidazole. In embodiments where the base is pyridine, imidazole and/or 1-methylimidazole the base may also act as solvent if present at sufficient volume. Suitably, the base is present in the reaction mixture at a proportion of 2-20 molar equivalents vs. the polysaccharide repeat unit, such as 5-15 molar equivalents, 8-12 molar equivalents or about 10 molar equivalents. Alternatively, the base, in particular pyridine (imidazole and/or 1-methylimidazole), can be used as solvent and is therefore present in a molar equivalent in excess of between about 25×(mol/mol) and about 100×(mol/mol), such as between about 40×(mol/mol) and about 75×(mol/mol), e.g. about 55×excess (mol/mol). Thus, in one embodiment the base and the solvent are the same entity e.g. in one embodiment both the base and the solvent are selected from the group consisting of pyridine, imidazole and 1-methylimidazole.

In one embodiment, the method comprises reacting the polysaccharide with a fatty acid or fatty acid ester; an activator; and a solvent, optionally in the presence of a base.

The reaction mixture is preferably stirred or agitated during the reaction, for example using a mechanical stirrer.

The method preferably further comprises heating the reaction mixture to a temperature of between room temperature and 300° C. Preferably, the temperature of the reaction mixture is at least 30° C., for example at least 80° C. The temperature of the reaction mixture is preferably no more than 200° C., no more than 130° C., preferably no more than 110° C. In one embodiment, the temperature of the reaction mixture is between room temperature and 200° C., such as between 30° C. to 130° C., preferably between 30° C. to 110° C., for example about 80° C.

In one embodiment, the temperature of the reaction mixture is 65-110° C., such as 70-110° C. or 75-110° C.

The method preferably further comprises precipitating the fatty acid derivative of a polysaccharide obtained from seaweed. The method preferably further comprises the addition of water and/or ethanol to initiate/cause precipitation of the at least one fatty acid derivative of polysaccharides obtained from seaweed. Alternatively, the method preferably further comprises the addition the reaction mixture to water and/or ethanol, to initiate/cause precipitation of the at least one fatty acid derivative of polysaccharides obtained from seaweed. In both cases, suitably, the precipitation is initiated/caused by the addition of ethanol.

Preferably, the method further comprises obtaining the fatty acid derivative of polysaccharides obtained from seaweed by filtration. Filtration may comprise vacuum filtration.

The precipitated fatty acid derivative of at least one polysaccharide obtained from seaweed may be washed, for example with hot ethanol, to remove further impurities.

The precipitated, and optionally washed, fatty acid derivative of at least one polysaccharide obtained from seaweed is preferably dried, for example oven dried. The fatty acid derivative(s) may for example be dried at a temperature of 50° C.

The reaction time for the reaction is preferably at least 30 minutes. The reaction time for the reaction is preferably no more than 72 hours. For example, the reaction time is preferably between 3 and 72 hours, for example between 3 and 24 hours, for example about 6 hours.

Preferred embodiments of the method of the invention are as follows:

In one embodiment, is provided a method of preparing a fatty acid derivative of a polysaccharide derived from seaweed, comprising:
reacting at least one polysaccharide derived from seaweed with a fatty acid source comprising a fatty acid; an activator; and a solvent;
wherein the solvent is selected from the group consisting of DMAc, DMF, pyridine, imidazole and 1-methylimidazole, and combinations thereof;
and wherein the activator is selected from the group consisting of trifluormethanesulfonyl chloride, p-toluenesulfonyl chloride and methanesulfonyl chloride; and mixtures thereof (and in particular is p-toluenesulfonyl chloride and/or methanesulfonyl chloride). Suitably, the molar ratio of the at least one fatty acid source to the polymer repeat unit of the at least one polysaccharide is in the range of from 3:1 to 10:1.

In one embodiment, is provided a method of preparing a fatty acid derivative of a polysaccharide derived from seaweed, comprising:
reacting at least one polysaccharide derived from seaweed with a fatty acid source comprising a fatty acid; an activator; and a solvent;
wherein at least 20% of the hydroxyl groups of the polysaccharide derived from seaweed have been esterified to form fatty acid esters, such as at least 25%, at least 30%, at least 35%, at least 40%, at least 45%, at least 50%, at least 55%, at least 60%, at least 65%, at least 70%, at least 75% or at least 80%;
wherein the solvent is selected from the group consisting of DMAc, DMF, pyridine, imidazole and 1-methylimidazole, and combinations thereof;
and wherein the activator is selected from the group consisting of trifluormethanesulfonyl chloride, p-toluenesulfonyl chloride and methanesulfonyl chloride; and mixtures thereof (and in particular is p-toluenesulfonyl chloride and/or methanesulfonyl chloride). Suitably, the molar ratio of the at least one fatty acid source to the polymer repeat unit of the at least one polysaccharide is in the range of from 3:1 to 10:1.

In one embodiment, is provided a method of preparing a fatty acid derivative of a polysaccharide derived from seaweed, comprising:
reacting at least one polysaccharide derived from seaweed with a fatty acid source comprising a fatty acid; an activator; and a solvent;
wherein the at least one polysaccharide is selected from one or more of: sodium alginate, agar (technical or biological grade), carrageenan, alginic acid, fucoidan, laminarin, or any combination thereof;
wherein at least 20% of the hydroxyl groups of the polysaccharide derived from seaweed have been esterified to form fatty acid esters, such as at least 25%, at least 30%, at least 35%, at least 40%, at least 45%, at least 50%, at least 55%, at least 60%, at least 65%, at least 70%, at least 75% or at least 80%;
wherein the solvent is selected from the group consisting of DMAc, pyridine and imidazole; and
wherein the activator is selected from the group consisting of trifluormethanesulfonyl chloride, p-toluenesulfonyl chloride and methanesulfonyl chloride; and mixtures thereof (and in particular is p-toluenesulfonyl chloride and/or methanesulfonyl chloride). Suitably, the molar ratio of the at least one fatty acid source to the polymer repeat unit of the at least one polysaccharide is in the range of from 3:1 to 10:1.

In one embodiment, is provided a method of preparing a fatty acid derivative of a polysaccharide derived from seaweed, comprising:
reacting at least one polysaccharide derived from seaweed with a fatty acid source comprising a fatty acid; an activator; and a solvent;
wherein the at least one polysaccharide is selected from one or more of: sodium alginate, agar (technical or biological grade), carrageenan, alginic acid, fucoidan, laminarin, or any combination thereof;
wherein the at least one fatty acid is selected from one or more of: octanoic, lauric acid, linoleic acid, palmitic acid, stearic acid, myristic acid, or any combination thereof;
wherein the activator is selected from the group consisting of trifluormethanesulfonyl chloride, p-toluenesulfonyl chloride and methanesulfonyl chloride; and mixtures thereof (and in particular is p-toluenesulfonyl chloride and/or methanesulfonyl chloride);
and wherein the solvent is selected from the group consisting of DMAc, DMF, pyridine, imidazole and 1-methylimidazole, and combinations thereof. Suitably, at least 20% of the hydroxyl groups of the polysaccharide derived from seaweed have been esterified to form fatty acid esters, such as at least 25%, at least 30%, at least 35%, at least 40%, at least 45%, at least 50%, at least 55%, at least 60%, at least 65%, at least 70%, at least 75% or at least 80%. Suitably, the molar ratio of the at least one fatty acid source to the polymer repeat unit of the at least one polysaccharide is in the range of from 3:1 to 10:1.

In one embodiment, is provided a method of preparing a fatty acid derivative of a polysaccharide derived from seaweed, comprising:
reacting at least one polysaccharide derived from seaweed with a fatty acid source comprising a fatty acid; an activator; and a solvent;
wherein at least 20% of the hydroxyl groups of the polysaccharide derived from seaweed have been esterified to form fatty acid esters, such as at least 25%, at least 30%, at least 35%, at least 40%, at least 45%, at least 50%, at least 55%, at least 60%, at least 65%, at least 70%, at least 75% or at least 80%;
wherein the at least one polysaccharide is selected from one or more of: sodium alginate, agar (technical or biological grade) and alginic acid;
wherein the at least one fatty acid is selected from one or more of: octanoic, lauric acid, linoleic acid, palmitic acid, stearic acid, myristic acid, or any combination thereof; and
wherein the activator is selected from the group consisting of trifluormethanesulfonyl chloride, p-toluenesulfonyl chloride and methanesulfonyl chloride; and mixtures thereof (and in particular is p-toluenesulfonyl chloride and/or methanesulfonyl chloride);
and wherein the solvent is selected from the group consisting of DMAc, DMF, pyridine, imidazole and 1-methylimidazole, and combinations thereof. Suitably, the molar ratio of the at least one fatty acid source to the polymer repeat unit of the at least one polysaccharide is in the range of from 3:1 to 10:1.

In one embodiment, is provided a method of preparing a fatty acid derivative of a polysaccharide derived from seaweed, comprising:
reacting at least one polysaccharide derived from seaweed with a fatty acid source comprising a fatty acid; an activator; and a solvent;
wherein at least 40% of the hydroxyl groups of the polysaccharide derived from seaweed have been esterified to form fatty acid esters, such as at least 45%, at least 50%, at least 55%, at least 60%, at least 65%, at least 70%, at least 75% or at least 80%;
wherein the at least one polysaccharide is selected from one or more of: sodium alginate, agar and alginic acid;
wherein the at least one fatty acid is palmitic acid or stearic acid;
wherein the activator is selected from the group consisting of trifluormethanesulfonyl chloride, p-toluenesulfonyl chloride and methanesulfonyl chloride; and mixtures thereof (and in particular is p-toluenesulfonyl chloride and/or methanesulfonyl chloride);
and wherein the solvent is selected from the group consisting of DMAc, DMF, pyridine, imidazole and 1-methylimidazole, and combinations thereof. Suitably, the molar ratio of the at least one fatty acid source to the polymer repeat unit of the at least one polysaccharide is in the range of from 3:1 to 10:1.

In one embodiment, is provided a method of preparing a fatty acid derivative of a polysaccharide derived from seaweed, comprising:
reacting at least one polysaccharide derived from seaweed with a fatty acid source comprising a fatty acid; an activator; and a solvent;
wherein the at least one polysaccharide is agar and the at least one fatty acid is palmitic acid or stearic acid;
wherein the activator is selected from the group consisting of trifluormethanesulfonyl chloride, p-toluenesulfonyl chloride and methanesulfonyl chloride; and mixtures thereof (and in particular is p-toluenesulfonyl chloride and/or methanesulfonyl chloride); and
wherein the solvent is selected from the group consisting of DMAc, pyridine, imidazole and 1-methylimidazole.

Suitably, the molar ratio of the at least one fatty acid source to the polymer repeat unit of the at least one polysaccharide is in the range of from 3:1 to 10:1. Suitably, at least 50% of the hydroxyl groups of the polysaccharide derived from seaweed have been esterified to form fatty acid esters, such as at least 55%, at least 60%, at least 65%, at least 70%, at least 75% or at least 80%.

In all of the above embodiments, when pyridine, imidazole and/or 1-methylimdazole are used as solvent, the pyridine, imidazole and/or 1-methylimidazole may also function as a base.

### Further Embodiments of the Invention

Clause 1. A method of preparing a fatty acid derivative of polysaccharides obtained from seaweed, comprising:
reacting at least one polysaccharide derived from seaweed with a fatty acid source comprising: a fatty acid or fatty acid ester; an activator; and a solvent, optionally in the presence of a base selected from one or more of: pyridine, triethylamine, 4-dimethylaminopyridine (DMAP).

Clause 2. A method as claimed in clause 1, in which the at least one polysaccharide is selected from one or more of: sodium alginate, agar (technical or biological grade), carrageenan, alginic acid, fucoidan, laminarin, pectin, or any combination thereof.

Clause 3. A method as claimed in either of clauses 1 and 2, in which the fatty acid source has a chain length of at least C₁₂.

Clause 4. A method as claimed in any one of clauses 1 to 3, in which the fatty acid source has a chain length of no more than C₁₈.

Clause 5. A method as claimed in any preceding clause, comprising heating the reaction mixture to a temperature of between room temperature and 300° C.

Clause 6. A method as claimed in clause 5, in which the temperature is at least 30° C., at least 80° C.

Clause 7. A method as claimed in either of clauses 5 and 6, in which the temperature is no more than 200° C., no more than 110° C.

Clause 8. A method as claimed in any preceding clause, in which the molar ratio of fatty acid source to the polymer repeat unit of carbohydrate derived from seaweed is between 0.1:1 and 10:1.

Clause 9. A method as claimed in any one of clauses 1 to 8, in which the at least one fatty acid source is a fatty acid ester.

Clause 10. A method as claimed in clause 9, in which the at least one fatty acid ester is selected from one or more of: an octanoate ester, a laurate ester, a linoleate ester, a palmitate ester, a stearate ester, a myristate ester, or any combination thereof.

Clause 11. A method as claimed in either of clauses 9 and 10, in which the at least one fatty acid ester is a methyl, ethyl, vinyl or glyceryl ester of the at least one fatty acid.

Clause 12. A method as claimed in clause 9, in which the at least one fatty acid ester is selected from one or more of: methyl palmitate, ethyl palmitate, glyceryl palmitate, vinyl palmitate, methyl stearate, ethyl stearate, vinyl stearate, glyceryl stearate or any combination thereof.

Clause 13. A method as claimed in any preceding clause, in which the base is pyridine.

Clause 14. A method as claimed in any one of clauses 1 to 13, in which the solvent is selected from one or more of: water, ethanol, toluene, acetonitrile, dimethylsulfoxide, 1,4-dioxane, dimethylformamide, chloroform, ethyl butyrate, dimethylacetamide.

Clause 15. A method as claimed in clause 14, in which the solvent is selected from one or more of: dimethylsulfoxide, dimethylformamide, dimethylacetamide, dimethylacetamide/lithium chloride, formamide, dichloromethane, chloroform, toluene, or any combination thereof.

Clause 16. A method as claimed in clause 15, in which the solvent is dimethylacetamide or dimethylformamide.

Clause 17. A method as claimed in any preceding clause, in which the activator is selected from one or more of: N,N′-dicyclohexylcarbodiimide, p-toluenesulfonyl chloride, methanesulfonyl chloride, 1,1′-carbonyldiimidazole, N,N′-diisopropylcarbodiimide, oxalyl chloride, thionyl chloride, acetic anhydride, trifluoroacetic anhydride or any combination thereof.

Clause 18. A method as claimed in any preceding clause, further comprising precipitating the fatty acid derivative of polysaccharides obtained from seaweed.

Clause 19. A method as claimed in clause 18 in which precipitation occurs on addition of water or ethanol to the reaction mixture.

Clause 20. A method as claimed in either of clauses 18 and 19, further comprising obtaining the fatty acid derivative of polysaccharides obtained from seaweed by filtration.

Clause 21. A method as claimed in any one of clauses 18 to 20, further comprising washing the fatty acid derivative of polysaccharides obtained from seaweed with water and/or ethanol, and subsequently drying.

### ABBREVIATIONS

CDI 1,1′-carbonyldiimidazole
DCC N,N′-dicyclohexylcarbodiimide
DIC N,N′-diisopropylcarbodiimide
DMAc dimethylacetamide
DMAP 4-dimethylaminopyridine
DMF dimethylformamide
DMSO dimethylsulfoxide
FTIR Fourier-transform infrared
MsCl methanesulfonyl chloride
TsCl toluenesulfonyl chloride

### Examples

### Evaluation Methods

### Determining the Extent of Functionalisation

The extent of esterification of the polysaccharide derived from seaweed corresponds to the percentage of hydroxyl groups of the polysaccharide derived from seaweed that have been esterified according to the method of the invention. The extent of esterification is quantified gravimetrically and is calculated as the ratio between weight gain after reaction and theoretical maximum weight of covalently bound fatty acid groups. This % value is also known as the functionalisation yield.

### Fourier-Transform Infrared Spectroscopy (FTIR)

Infrared (FTIR) spectra were recorded on a Perkin Elmer Frontier FT-IR equipped with a zinc selenide crystal ATR module. Each spectrum was recorded with 8 scans between 4,000 and 400 cm⁻¹, with a resolution of 4 cm⁻¹. FTIR spectra are plotted as transmittance (%) vs. wavelength (cm⁻¹). Intensity of a particular signal is reported as % transmittance (% T) of the signal's maximum (minimum transmittance value). In the Examples below where the palmitate derivative of agar is formed, the new ester moieties produce a new ester signal at ca. 1742 cm⁻¹. Absence of this signal generally indicates absence of ester groups; when the signal is observed, transmittance values close to 100% (for example 98% or 95%) generally indicate low concentration of ester groups, while lower values (for example 80% or 70%, corresponding to 20% and 30% absorbance, respectively), generally indicate higher concentration of ester groups.

### Example 1—Investigation of Esterification Reaction Conditions

In order to determine suitable reaction conditions for forming a fatty acid derivatised polysaccharide, agar (0.5 g) was suspended with various palmitic acyl functionalisation agents (5 molar equivalents per repeat unit of the polysaccharide), in pyridine (7.5 ml), optionally in the presence of an activator (5 molar equivalents per repeat unit of the polysaccharide). Each reaction mixture was stirred at 105° C. for 24 hours under magnetic stirring. The results are shown in Table 1 below. The functionalisation yield and FTIR intensity were calculated as set out in Evaluation Methods.

TABLE 1
Functionalisation yield and FTIR intensity for various palmitic acyl
functionalisation agents, optionally in the presence of an activator

| Functionalisation | | Funct. | FTIR % |
|---|---|---|---|
| agent | Activator | Yield (%) | T ~1742 cm − 1 |
| Palmitoyl chloride | — | 73 | 73 |
| Palmitic acid | — | 0 | 100 |
| Methyl palmitate | — | 0 | 100 |
| Palmitic anhydride | — | 2 | 91 |
| Palmitic acid | TsCl | 60 | 77 |

It can be seen that reaction with the acid chloride palmitoyl chloride produced the desired fatty acid derivatised agar ester in a functionalisation yield of 73%, with 73% FTIR ester transmittance. Reaction with methyl palmitate and palmitic anhydride yield an insignificant amount of, or no, fatty acid derivatised ester. Palmitic acid also failed to produce any esterified product, but when combined with the activator TsCl produced the desired fatty acid derivatised ester in a functionalisation yield of 60%, with 77% FTIR ester transmittance. As such, using a fatty acid as functionalisation agent together with the activator TsCl avoids the use acyl chlorides while providing material which is equally good in terms of functionalisation yield and % FTIR ester transmittance.

### Example 2—Method for the Formation of Functionalised Polysaccharide Derived from Seaweed Using Fatty Acid, TsCl as Activator

Pre-dried (50° C., overnight) agar (1 g) and palmitic acid (5.0-8.0 molar equivalents vs. polymer repeat unit) are suspended in a solvent (selected from DMAc, DMF, pyridine, imidazole and 1-methylimidazole, and combinations thereof)) (7.5 ml) into a round bottom flask under magnetic stirring. An activator, p-toluenesulfonyl chloride (5.0-8.0 molar equivalents vs. polymer repeat unit) is added. The mixture is stirred at 60-130° C. for 6 to 72 hours under magnetic or mechanical stirring. The mixture is then cooled. Ethanol is added, the solid filtered under reduced pressure and washed repeatedly with hot ethanol to provide a palmitic acid ester agar. Using 5.0 molar equivalents of TsCl and DMAc as solvent, heated at 80° C. for 24 hours, the desired palmitate agar ester was produced with a functionalisation yield of 53% and % FTIR ester transmittance of 75% (calculated as set out in the Evaluation Methods).

### Example 3—Method for the Formation of Functionalised Polysaccharide Derived from Seaweed Using Fatty Acid, DCC as Activator and Optionally a Base

Pre-dried (50° C., overnight) agar (0.5 g) and palmitic acid (5.0 molar equivalents vs. polymer repeat unit) are suspended in dimethylacetamide (7.5 ml) into a round bottom flask under magnetic stirring. An activator, N,N′-dicyclohexylcarbodiimide (6.0 molar equivalents vs. polymer repeat unit) and optionally a base, 4-dimethylaminopyridine (0.8 molar equivalents vs. polymer repeat unit) are added. The mixture is stirred at 40-80° C. for 5 to 24 hours under magnetic stirring. The mixture is then cooled. Ethanol is added, the solid filtered under reduced pressure and washed repeatedly with hot ethanol to provide a palmitic acid ester agar.

### Example 4—Characterisation of Functionalised Polysaccharides Derived from Seaweed

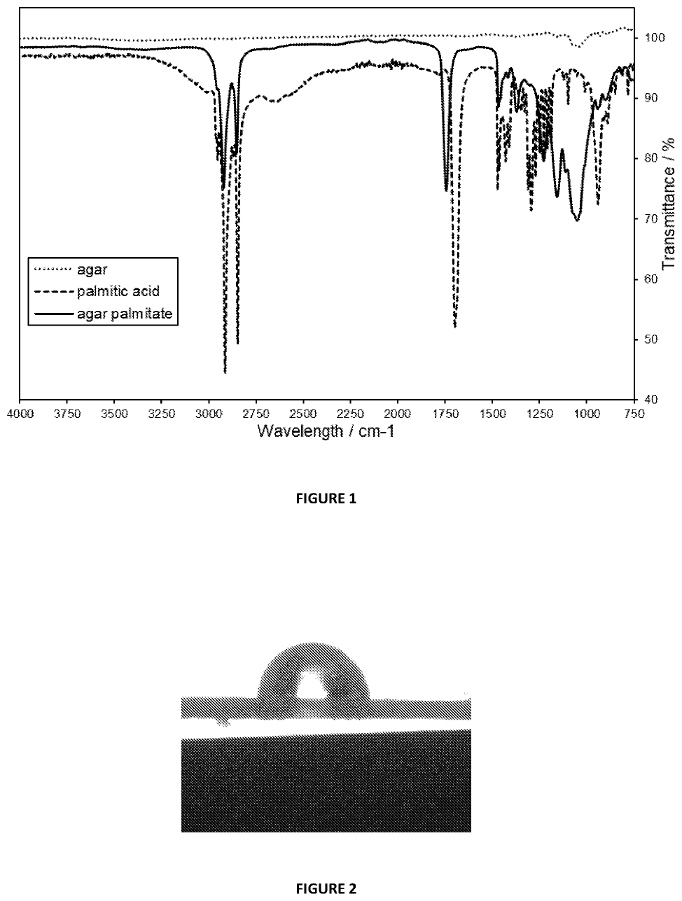

The functionalised polysaccharides were evaluated using FTIR, as set out in Evaluation Methods. FIG. 1 illustrates the overlapped infrared spectrum of agar, palmitic acid and agar palmitate formed according to the method of Example 2, carried out at 80° C. for 24 hours. The new ester signal is clearly visible at ca. 1742 cm⁻¹. The functionalisation yield was determined to be 53%.

### Examples 5—Further Investigation of Reaction Conditions

Agar was reacted with palmitic acid in the presence of differing types and amounts of activators and bases, over differing time periods. Table 2 summarises the reaction conditions, the intensity (as % transmittance) of the signal at 1742 cm⁻¹ of the newly formed ester group during the functionalisation reaction, and the functionalisation yield (determined as set out in Evaluation Methods). The first entry in Table 2 corresponds to the agar functionalised with palmitic acid as prepared in Example 2.

TABLE 2

| | | | | | | Funct. |
|---|---|---|---|---|---|---|
| Activator | Base | | Temp. | Time | FTIR (% T | Yield |
| (Molar eq*) | (Molar eq*) | Solvent | (° C.) | (h) | @1742 cm⁻¹) | (%) |
| TsCl (5.0) | — | DMAc | 80 | 24 | 75 | 53 |
| TsCl (5.0) | — | DMAc | 60 | 24 | 93 | 4 |
| TsCl (5.0) | — | DMAc | 80 | 6 | 88 | 9 |
| TsCl (8.0) | — | DMAc | 80 | 24 | 74 | 39 |
| TsCl (5.0) | — | DMAc + LiCl | 80 | 24 | 79 | 4 |
| | | (20 mol %) | | | | |
| TsCl (5.0) | — | DMF | 80 | 24 | 80 | 41 |
| TsCl (5.0) | — | DMAc | 80 | 72 | 76 | 18 |
| TsCl (5.0) | Pyridine (10.0) | DMAc | 80 | 24 | 91 | — |
| MsCl (5.0) | — | DMAc | 80 | 24 | 75 | 51 |
| MsCl (5.0) | — | DMF | 80 | 24 | 81 | 39 |
| DIC (5.0) | DMAP (0.8) | DMAc | 80 | 24 | 99 | 1 |
| DIC (5.0) | DMAP (0.8) | DMAc | 40 | 24 | 94 | 7 |
| DCC (5.0) | DMAP (0.8) | DMAc | 80 | 5 | 84 | 16 |
| DCC (5.0) | DMAP (0.8) | DMAc | 40 | 24 | 87 | 12 |
| CDI (5.0) | DMAP (0.8) | DMAc | 80 | 24 | 96 | 3 |
| CDI (5.0) | — | DMAc | 80 | 24 | 95 | 3 |
| TsCl (5.0) | Pyridine** | pyridine | 80 | 3 | 92 | 14 |
| TsCl (5.0) | Pyridine** | pyridine | 105 | 3 | 86 | 48 |
| TsCl (5.0) | Pyridine** | Pyridine | 105 | 24 | 77 | 60 |
| TsCl (5.0) | Pyridine** | pyridine | 80 | 24 | 86 | 38 |
| TsCl (5.0) | Imidazole** | imidazole | 115 | 6 | 77 | 69 |
| TsCl (5.0) | Imidazole** | imidazole + | 105 | 6 | 86 | 62 |
| | | toluene (1:1) | | | | |
| TsCl (5.0) | Imidazole** | imidazole + | 105 | 6 | 84 | 51 |
| | | DMAc (3:1) | | | | |
| TsCl (5.0) | 1- | 1- | 105 | 6 | 92 | 25 |
| | methylimidazole** | methylimidazole | | | | |
| TsCl (5.0) | imidazole + 1- | imidazole + 1- | 105 | 6 | 94 | 32 |
| | methylimidazole** | methylimidazole | | | | |
| | | (3:1) | | | | |
| TsCl (8.0) | Imidazole** | imidazole | 105 | 6 | 75 | 68 |

*vs polysaccharide repeat unit
**used as solvent, therefore >25 (total if more than one base is present)

The Examples in Table 2 demonstrate methods for preparing fatty-acid esterified polysaccharides derived from seaweed using differing types and amounts of activators and bases, over differing time periods and at different temperatures. It is to be understood that the methods of the present invention can be carried out using any polysaccharide derived from seaweed, with any suitable fatty acid or fatty acid ester and is not to be limited to the fatty acid sources specified in the Examples.

### Example 6—Hydrophobic Nature of Fatty Acid Derivatised Polysaccharide

Agar functionalised with palmitic acid, prepared according to Example 2 (Table 2, entry 1), exhibits a hydrophobic nature due to the presence of the long chain hydrocarbon moieties. When agar is placed into a beaker of water it sinks to the bottom and swells, whereas the agar functionalised with palmitic acid swims on the water surface without any absorption of water occurring.

The repellence of water was further demonstrated by placing a droplet of water onto the surface of a sheet of agar functionalised with palmitic acid (produced by hot pressing the material into a sheet). FIG. 2 shows the water droplet beading on the surface with a contact angle of 92° highlighting the hydrophobic nature of the material. Liquid water did not permeate through a sheet of the material for at least 72 hours (maximum testing time).

1. A method of preparing a fatty acid derivative of a polysaccharide derived from seaweed, comprising:
reacting at least one polysaccharide derived from seaweed with a fatty acid source comprising: a fatty acid or fatty acid ester; an activator; and a solvent.

2. The method as claimed in claim 1, wherein at least 20% of the hydroxyl groups of the polysaccharide derived from seaweed have been esterified to form fatty acid esters, such as at least 25%, at least 30%, at least 35%, at least 40%, at least 45%, at least 50%, at least 55%, at least 60%, at least 65%, at least 70%, at least 75% or at least 80%.

3. The method as claimed in claim 1, in which the at least one polysaccharide is selected from one or more of: an alginate salt (e.g. sodium alginate, calcium alginate or potassium alginate), agar (technical or biological grade), agarose, ulvan, carrageenan, alginic acid, fucoidan, laminarin, or any combination thereof.

4. The method as claimed in claim 1, in which the fatty acid source has a chain length of at least C₁₂.

5. The method as claimed in claim 1, in which the fatty acid source has a chain length of no more than C₁₈.

6. The method as claimed in claim 1, further comprising heating the reaction mixture to a temperature of between room temperature and 300° C.

7. The method as claimed in claim 6, in which the temperature is at least 30° C., at least 80° C.

8. The method as claimed in claim 6, in which the temperature is no more than 200° C., no more than 130° C., or no more than 110° C.

9. The method as claimed in claim 1, in which the molar ratio of fatty acid source to the polymer repeat unit of polysaccharide derived from seaweed is between 0.1:1 and 10:1.

10. The method as claimed in claim 1, in which the at least one fatty acid source is a fatty acid ester.

11. The method as claimed in claim 10, in which the at least one fatty acid ester is selected from one or more of: an octanoate ester, a laurate ester, a linoleate ester, a palmitate ester, a stearate ester, a myristate ester, or any combination thereof.

12. The method as claimed in claim 10, in which the at least one fatty acid ester is a methyl, ethyl, vinyl or glyceryl ester of the at least one fatty acid.

13. The method as claimed in claim 12, in which the at least one fatty acid ester is selected from one or more of: methyl palmitate, ethyl palmitate, glyceryl palmitate, vinyl palmitate, methyl stearate, ethyl stearate, vinyl stearate, glyceryl stearate or any combination thereof.

14. The method as claimed in claim 1, in which the at least one fatty acid source is a fatty acid.

15. The method as claimed in claim 14, in which the at least one fatty acid is selected from one or more of: octanoic, lauric acid, linoleic acid, palmitic acid, stearic acid, myristic acid, or any combination thereof.

16. The method as claimed in claim 1, wherein the reaction is carried out in the presence of a base.

17. The method as claimed in claim 16, in which the base is selected from the group consisting of pyridine, triethylamine, 4-dimethylaminopyridine (DMAP), imidazole and 1-methylimidazole.

18. The method as claimed in claim 17, in which the base is pyridine, DMAP, imidazole or 1-methylimidazole.

19. The method as claimed in claim 18, wherein the base is pyridine, imidazole or 1-methylimidazole.

20. The method as claimed in claim 1, in which the solvent is selected from the group consisting of: water, ethanol, acetonitrile, 1,4-dioxane, ethyl butyrate, dimethylacetamide (DMAc), dimethylformamide (DMF), formamide, toluene, dimethylsulfoxide (DMSO), pyridine, chloroform, dichloromethane, dimethylacetamide/lithium chloride, imidazole and 1-methylimidazole; and combinations thereof.

21. The method as claimed in claim 1, in which the solvent is non aqueous.

22. The method as claimed in claim 1, in which the solvent is selected from the group consisting of one or more of: DMAc, DMF, formamide, pyridine, imidazole and 1-methylimidazole; and combinations thereof.

23. The method as claimed in claim 22, in which the solvent is DMAc, pyridine, imidazole or 1-methylimidazole; or a combination thereof.

24. The method as claimed in claim 1, wherein for every gram of polysaccharide derived from seaweed, 1-250 mL, such as 2-50 mL, such as 4-30 mL or about 15 mL of solvent is used.

25. The method as claimed in claim 1, in which the activator is selected from one or more of: N,N′-dicyclohexylcarbodiimide, trifluoromethanesulfoyl chloride, p-toluenesulfonyl chloride, methanesulfonyl chloride, 1,1′-carbonyldiimidazole, N,N′-diisopropylcarbodiimide, acetic anhydride, trifluoroacetic anhydride or any combination thereof.

26. The method as claimed in claim 25, in which the activator is selected from one or more of trifluoromethanesulfoyl chloride, p-toluenesulfonyl chloride and methanesulfonyl chloride; and in particular is p-toluenesulfonyl chloride and/or methanesulfonyl chloride.

27. The method as claimed in claim 1, wherein the activator is present in the reaction mixture at a proportion of 2-20 molar equivalents vs. the polysaccharide repeat unit, such as 2-10 molar equivalents, 5-8 molar equivalents, 4-6 molar equivalents, or about 5 molar equivalents.

28. The method as claimed in claim 1, further comprising precipitating the fatty acid derivative of polysaccharides obtained from seaweed.

29. The method as claimed in claim 24, in which precipitation occurs on addition of water or ethanol to the reaction mixture.

30. The method as claimed in claim 28, further comprising obtaining the fatty acid derivative of polysaccharides obtained from seaweed by filtration.

31. The method as claimed in claim 28, further comprising washing the fatty acid derivative of polysaccharides obtained from seaweed with water and/or ethanol, and subsequently drying.
